(19) United States
(12) Patent Application Publication
(10) Pub. No.: US 2009/0199949 A1
(43) Pub. Date: Aug. 13, 2009

(54) Disposable Connector For Use With Endoscopic Apparatus

(75) Inventors: Golan Salman, Atlit (IL); Amram Aizenfeld, Kibbutz Ramot Menashe (IL); Michael Voloshin, Haifa (IL)

Correspondence Address: Lilling & Lilling PLLC, PO Box 435, Jerusalem, 91003, IL

(73) Assignee: STRYKER GI LTD., Caesarea (IL)

(21) Appl. No.: 12/108,182

(22) Filed: Apr. 23, 2008

Related U.S. Application Data
(60) Provisional application No. 60/916,844, filed on May 9, 2007.

(51) Int. Cl. B32B 37/02

(52) U.S. Cl. 156/64; 156/515; 156/251

(57) ABSTRACT

A device for sealing and cutting a disposable multilumen tubing used with an endoscopic apparatus is disclosed. The device comprises a first jaw and a second jaw pivotally articulated to one another, each having a front portion and a rear portion. At least one heating assembly is fixed within the front portion of at least one of the jaws, said heating assembly having a heating element. There also is wiring for connecting the heating assembly to an energy source, supplying electrical power thereto. At least one operating handle engagement portion is provided, which positions the device with respect to a port provided at an operating handle of the endoscopic apparatus and secures the device with respect to the multilumen tubing.

### FIELD OF THE INVENTION

The present invention relates generally to the field of endoscopy and specifically to endoscopic apparatus used for colonoscopic procedures during which a flexible tube is inserted into the rectum and colon for examination of the colon interior. More particularly, the present invention refers to a method and device for heat-sealing and cutting of disposable multilumen tubing, used specifically, but not exclusively, with an endoscopic apparatus.

### BACKGROUND OF THE INVENTION

There are known endoscopes provided with an internal sleeve, which is also known as a multilumen tubing, since it comprises a plurality of passages or lumens for irrigation/flushing, suction and for passing endoscopic tools therethrough. During the endoscopic procedure the multilumen tubing is exposed to contaminated body liquids and secretions.

After the endoscopic procedure is completed, the endoscope is retracted from the body passage and there is a possibility for contaminating the endoscope's guiding channel by liquid or debris, which enter into the multilumen tubing during the endoscopic procedure and could leak out through the proximal extremity of the multilumen tubing as it is pulled out through the guiding channel.

Canon Kabushika Kaisha (International Patent Publication No. WO 2003/000661) mentions a possibility of prevention of the contamination either by placing a tightly-fitting cup over the proximal extremity of the multilumen tubing in order to seal its interior off, or by crimping or heat-sealing the proximal extremity of the multilumen tubing.

Bar-Or (International Patent Publication No. WO 2005/110199) describes a method and device for cutting and sealing of disposable multilumen tubing. The method comprises placing a portion of the multilumen tubing between two surfaces and applying heat and pressure to at least one of the surfaces so as to plastically deform and cut the said portion of the multilumen tubing and to heat-seal the cut ends thereof. The device for cutting and sealing comprises a first jaw juxtaposed with a second jaw, said first and said second jaw being provided with respective first and second surfaces. A biasing member exerts pressure on at least one of the said first and the second surfaces and a source of energy provides heating of at least one of the said first and the second surfaces.

Takahashi (U.S. Pat. No. 5,050,585) mentions fusion-cutting of a channel tube of an endoscope to prevent contamination of a guide tube. The cut portion of the channel tube is fusion-bonded by the heat applied during fusion-cutting process and the end of the channel tube is thereby closed. In this case the channel tube is left connected to the connecting adapter.

### SUMMARY OF THE INVENTION

The present invention is generally concerned with heat-sealing and cutting of a disposable multilumen tubing used with an endoscopic apparatus, for preventing leakage of contaminated liquids accumulated within the multilumen tubing during the endoscopic procedure.

In accordance with one aspect of the present invention, there is provided a device for heat-sealing and cutting (further referred-to also as thermal pinch cutter or simply as TPC) of a disposable multilumen tubing used with an endoscopic apparatus. The device has a first jaw and a second jaw pivotally articulated to one another, each having a front portion and a rear portion. At least one heating assembly is fixed within the front portion of at least one of the jaws, and having a heating strip tensioned over an anvil. There are wires connecting the heating assembly to an energy source, supplying electrical power thereto.

The first jaw and the second jaw of the device are normally biased such that the front portions thereof are kept in a closed position. In an open position, a tube receiving gap is created between the front portions of the first and the second jaws to allow the multilumen tubing to be received therebetween. The size of the tube receiving gap may be monitored by an optical means or any other mechanism generating size responsive indicia.

The device further comprises at least one operating handle engagement arrangement to facilitate positioning and fixation of the device to a port of the operating handle of the endoscopic apparatus and to the multilumen tubing.

According to one embodiment of the present invention the engagement arrangement forms an at least partially embracing configuration for gripping with the port and the multilumen tubing.

According to another embodiment of the present invention, the engagement arrangement comprises at least two first arched protrusions for positioning the device and fixing it to the operating handle.

Any one or more of the following features may be included in the device according to the present invention.

The device may further comprise internal components, such as a coiled spring or other biasing arrangements for retaining the device in a normally closed position, and additional control elements, such as a printed circuit board comprising electronic components for controlling heating time and temperature, condensers for filtering communication signals between the device and the power supply source, memory chips, etc.

The device may further comprise optical means, such as an optical switch, cooperating with a comb-like element, generating a signal corresponding to the size of the tube receiving gap between the jaws of the device.

The heating assembly may further comprise a tensioning assembly for adjusting the tension of the heating strip over the anvil.

The anvil of the heating assembly is made of heat resistant materials for resisting temperatures up to 250° C.

The heating strip may be a very thin strip allowing quick heat dissipation.

The device may further comprise a heat hazard indication, such as an illuminated indication e.g. LED, which is turned on at the beginning of the heat-sealing process.

According to a further aspect of the present invention, there is provided a method for heat-sealing and cutting a disposable multilumen tubing used with an endoscopic apparatus. The steps of the method are: Providing a device having a first jaw and a second jaw pivotally articulated to one another, at least one heating assembly fixed within the front portion of at least one of the jaws, said heating assembly comprising a heating strip tensioned over an anvil, and wires connecting the heating assembly to an energy source, supplying electrical power thereto; Opening the jaws to allow positioning of the multilumen tubing within a tube receiving gap provided between the first and the second jaws; Initial squeezing of the multilumen tubing, which takes place when the jaws of the device are released and begin to approach each other, thereby squeezing the multilumen tubing; Applying electrical power to the heating strip for heat-sealing of the multilumen tubing, which begins when the jaws reach a predetermined desired closing state, i.e. a desired size of the tube receiving gap; and Cutting a sealed portion of the multilumen tubing, which occurs as a result of simultaneous applying of pressure and heat.

After completing the heat-sealing and cutting process the multilumen tubing has two separate portions with heat-sealed edges, thereby preventing the contamination accumulated during the endoscopic procedure from leaking out from the multilumen tubing.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIG. 1A is an isometric view of a thermal pinch cutter (TPC) according to a present invention, applied over a multilumen tubing of an endoscopic apparatus;

FIG. 1B is a side view of the TPC seen in FIG. 1A;

FIG. 2A is an exploded isometric view of a heating assembly of the TPC;

FIG. 2B is an isometric view of a front portion of the TPC with a first jaw removed so as to expose the heating assembly thereof;

FIG. 2C is an isometric view of a heating assembly with electrical wires connected thereto;

FIG. 3A is a second side view of the TPC, made transparent to visualize the internal structure and components thereof;

FIG. 3B is a exploded second side isometric view of the TPC;

FIG. 3C is a side view of the TPC, made transparent to visualize the internal structure and components thereof;

FIG. 3D is an exploded side isometric view of the TPC;

FIG. 4 is a top isometric view of a first jaw of the TPC;

FIG. 5 is an isometric view of portions of an endoscopic device illustrating the multilumen tubing being cut by the TPC according to the present invention; and

FIG. 6 is an isometric view of the TPC being attached to a connector by an arm.

### DETAILED DESCRIPTION OF EMBODIMENTS

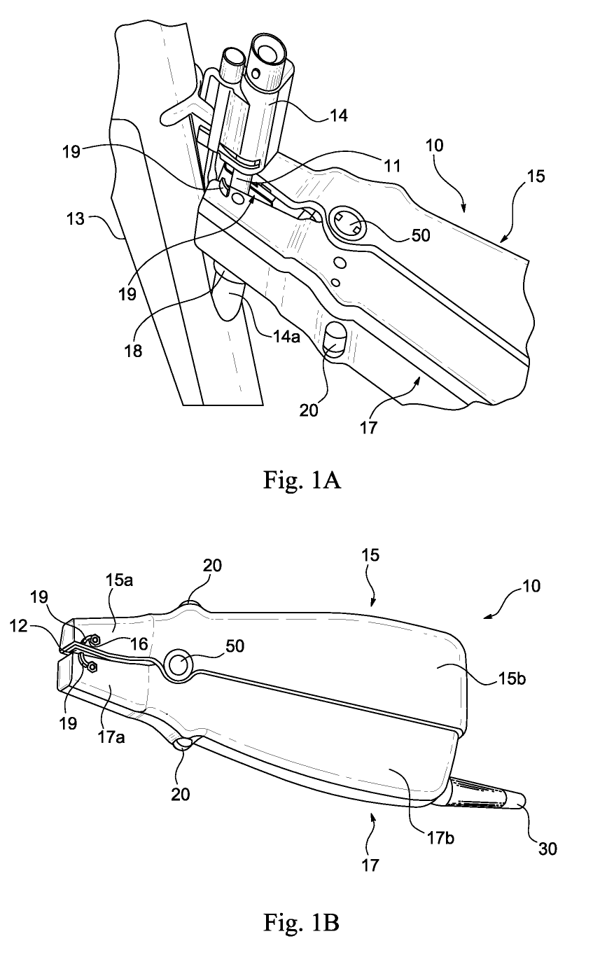

FIG. 1A illustrates a thermal pinch cutter (hereinafter TPC) generally designated 10 for heat-sealing and cutting a disposable multilumen tubing 11 at the end of an endoscopic procedure. The multilumen tubing 11 extends along an insertion tube of an endoscopic apparatus. The multilumen tubing begins at an optical head, passes the insertion tube and exits through a port 14a of an operating handle 13 to a connector 14. As will be explained hereinafter, at the end of the endoscopic procedure, the TPC 10 is used for heat-sealing and cutting the multilumen tubing 11, thereby preventing the spreading of contaminations from inside the multilumen tubing 11.

As shown in FIGS. 1A and 1B, the TPC 10 is an ergonomically designed hand-held device comprising a first jaw 15 and a second jaw 17, pivotally articulated to one another with respect to an axle 50. Each jaw has a front portion 15a and 17a and a rear portion 15b and 17b, respectively. The jaws can be made from a plastic material by an injection molding process. The multilumen tubing 11 is positioned in a tube receiving gap 12 provided between the front portions 15a and 17a of the jaws.

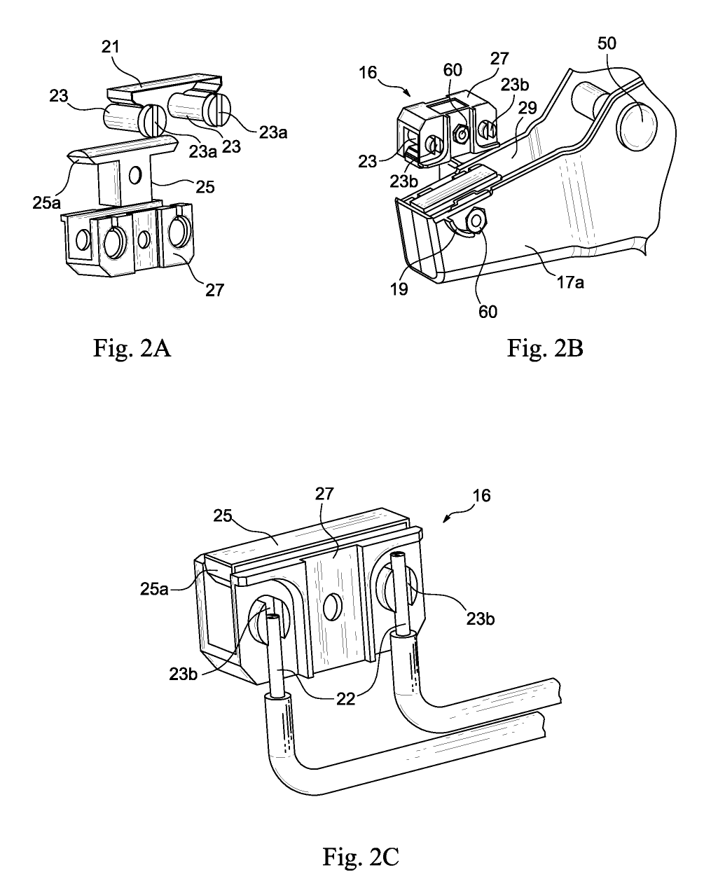

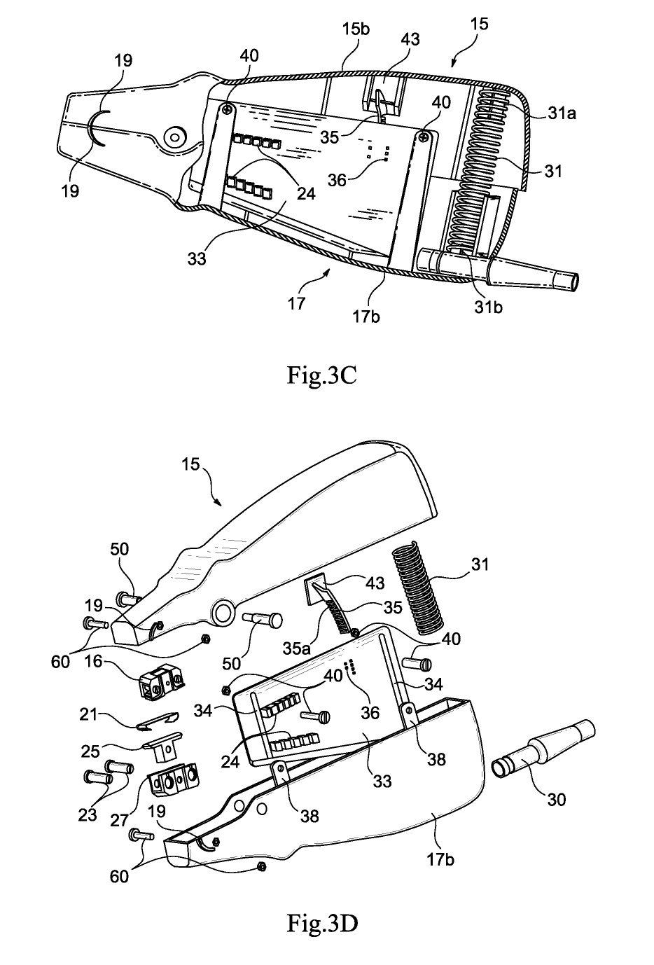

The TPC further comprises heating assemblies 16, which will be later described in detail with reference to FIGS. 2A, 2B and 2C. The heating assemblies are situated within a space provided in each of the front portions 15a and 17a of the jaws. Each jaw has a first arched wing-like protrusion 18 and a second arched wing-like protrusion 19 (FIGS. 1A and 4) at an opposite face of the jaw. The first and the second arched wing-like protrusions of the jaw 15 cooperate as a functional couple with the first and the second arc wing-like protrusions of the jaw 17, and form an at least partially embracing configuration for gripping with the exposed region of the multilumen tubing 11 and with the port 14a, as will be explained hereinafter.

The TPC further comprises a port 30 for passing a wire electrically connecting the heating assemblies 16 to an electrical power supply source for energizing the heating assemblies and for energizing various electronic components, residing within the device. Furthermore, on the opposite sides of the device there are provided heat hazard illuminating indications 20.

FIGS. 2A, 2B and 2C illustrate the heating assembly 16. As shown in FIG. 2A, the heating assembly 16 comprises the following elements: a heating strip 21, tensioning pins 23, an anvil 25 and a housing 27, fixedly received within a space 29 provided in the front portions 15a and 17a. The space 29 is shown in FIG. 2B. In practice, the heating strips are made of metal or from other electrically conductive material, which has good heat dissipating properties. The anvil and the housing are made of electrically non-conductive material, which has good heat resistance and is easily workable. An example of a suitable material is the plastic material, know under the trade name PEEK.

The anvil is fastened to the housing by a bolt-and-nut fastening 60. At the assembled position, the heating strip 21 is tensioned over opposite trimmed edges 25a of the anvil 25, which, in turn, is received within a slot in the housing 27. The tensioning pins 23 project through the housing 27, such that the slots 23a made in the pin heads are accessible for tensioning the heating strip 21 on the anvil by rotating the pins in opposite directions. The opposite ends of the tensioning pins 23 are provided with slots 23b (FIGS. 2B and 2C) for inserting electrical wires, thereby connecting the heating assembly 16 to the power supply source. It should be appreciated that tensioning of the strips, fastening of the anvils in respective housings, connecting of the current leading wires and placing the heating assemblies in the respective jaws takes place when the device is being assembled.

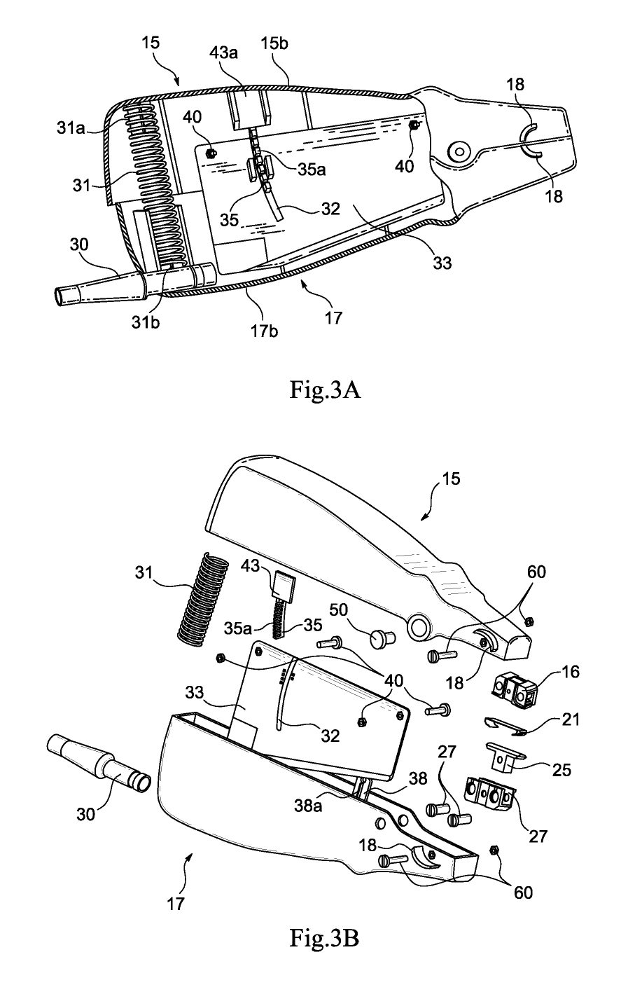

FIGS. 3A, 3B, 3C and 3D illustrate the internal structure and components of the TPC 10. The jaws 15 and 17 are hollow shaped portions, the jaw 15 having a greater cross section than the jaw 17, thereby allowing the jaw 17 to be received within the jaw 15. The internal components received inside the rear portions 15b and 17b of the jaws 15 and 17 are the following: a coiled spring 31, a printed circuit board (PCB) 33, and a comb-like element 35. The spring 31 is located between the rear portions 15b and 17b of the respective jaws, and is fixedly held in place by a first spring holder 31a and a second spring holder 31b (as shown in FIGS. 3A and 3C), thereby biasing the jaws of the TPC 10 into a normally closed state, i.e. wherein the tube receiving gap 12 is closed (FIGS. 1B, 3A and 3C).

The PCB 33 (FIGS. 3A to 3D) comprises an optical switch (not shown), memory chips (not shown) and other electronic components for controlling the heating time, heating temperature, etc. The PCB 33 further comprises a plurality of condensers 24 (FIGS. 3C and 3D) for filtering communication signals between the TPC and the power supply source. The PCB 33 is formed with a curved guiding region 32, which is free of the electronic components (FIGS. 3A and 3B) and two PCB positioning regions 34 (FIG. 3D). The PCB 33 is connected to tabs 38 provided at the face of the rear portion 17b. The PCB is connected to the tabs by bolt-and-nut connections 40. The tabs 38 have ribs 38a (FIG. 3B), which touch the positioning regions 34, when the PCB is being placed within the rear portion 17b. By virtue of this provision the PCB 33 is securely positioned within the rear portion.

A comb-like element 35 is provided. This element has an arched tail portion having a plurality of teeth thereon and a head portion 43, which is attached to the face of the rear portion 15b of the first jaw 15, as shown in FIG. 4. The tail portion is slideably positioned within the guiding region 32. An optical switch is provided, which is located on the PCB 33. The comb-like element 35 can slide along the guiding region 32 and thus a relative displacement is possible between the optical switch and the comb-like element when the jaws are being pivotally articulated. By virtue of this displacement, there is generated an electrical signal indicating the state of depression of the front portions 15a and 15b of the jaws 15 and 17, corresponding to the state of opening/closing of the tube receiving gap 12.

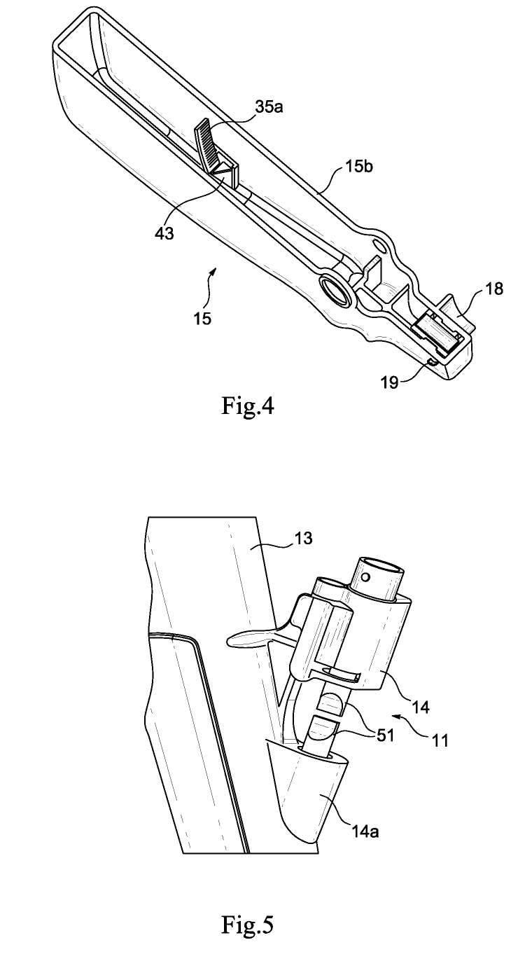

The TPC 10 is used at the end of the endoscopic procedure, when the endoscope is withdrawn from the body of a patient and is put on a stand, such that the operating handle is suspended and directed vertically as seen in FIGS. 1A and 5. In order to begin the heat-sealing and cutting of the multilumen tubing 11, the TPC 10 is brought into engagement therewith, by depressing the rear portions 15b and 17b to thereby open the tube receiving gap 12. When the tube receiving gap 12 is sufficiently opened, such that the multilumen tubing 11 is received within the gap, the rear portions 15b and 17b are released and, while the front portions 15a and 17a of the jaws 15 and 17 are approaching each other, the comb-like element 35 slides down along the curved guiding region 32 and the optical switch counts the teeth of the comb-like element 35, so as to determine the relative position of the jaws 15 and 17, corresponding to the size of the tube receiving gap 12.

In this position, the first arc wing-like protrusions 18 are engaged with the port 14a (FIG. 1A) and the second arc wing-like protrusions 19 engage the exposed portion of the multilumen tubing 11, thereby preventing the TPC 10 from spontaneous disconnecting and falling down.

Only when the jaws 15 and 17 reach the predetermined desired closing state, and after the multilumen tubing 11 has been already squeezed to some extent between the jaws, power is supplied to the heating strips 21 to trigger the heat-sealing and cutting process of the multilumen tubing 11. The heating time and temperature are predetermined and controlled by the PCB 33. At the end of the heat-sealing process, the multilumen tubing 11 is cut due to the pressure applied thereto by the heating assemblies associated with front portions 15a and 17a. The heat hazard illuminated indications 20 are turned on at the beginning of the heat-sealing and cutting process, and turned off only after the multilumen tubing 11 has been cut.

FIG. 5 illustrates the result of the heat-sealing and cutting procedure of the multilumen tubing 11. Both edges 51 of the multilumen tubing 11 are completely sealed and there is no possibility for the contamination accumulated in the multilumen tubing during the endoscopic procedure to leak out therefrom.

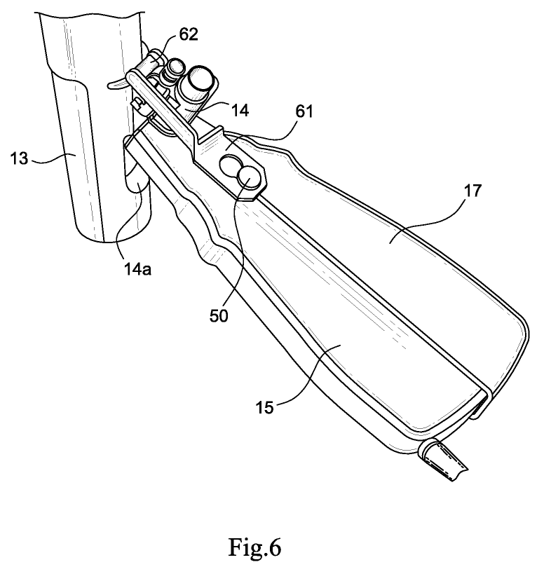

FIG. 6 shows how the TPC of the present invention is attached to the connector 14 of an endoscopic apparatus by an auxiliary arm 61, which is detachably attachable to the axle 50 and can pivot with respect thereto. The arm is provided with a catch portion 62, which, when the arm has been pivoted in a position seen in FIG. 6, elastically snaps around the connector and secures the TPC in place.

One should bear in mind, however, that the cutting does not necessarily need to be carried out by the device itself, and instead it could be done by an auxiliary cutting means, e.g. by scissors.

One should also bear in mind that at least one heating assembly could be fitted with heating elements designed differently from the heating strip. Furthermore, at least one heating assembly could be fitted with an anvil which is integral with the heating element, instead of having a separate heating strip.

The invention is described in detail with reference to a particular embodiment, but it should be understood that various other modifications can be effected and still be within the spirit and scope of the invention

We claim:

1. A device for sealing and cutting a disposable multilumen tubing used with an endoscopic apparatus, the device comprising:
(a) a first jaw and a second jaw pivotally articulated to one another, each jaw having a front portion and a rear portion;
(b) at least one heating assembly fixed within the front portion of at least one of the jaws, said heating assembly comprising a heating element said at least one heating assembly is electrically connectable to an energy source;
(c) at least one operating handle engagement portion for positioning the device with respect to a port provided at an operating handle of the endoscopic apparatus and for fixation of the device with respect to the multilumen tubing.

2. A device according to claim 1, wherein said jaws being pivotable to form a tube receiving gap created between respective front portions of the first and the second jaws.

3. A device according to claim 1, wherein the first jaw and the second jaw being normally biased in a normally closed position wherein the front portions thereof being in vicinity of each other.

4. A device according to claim 1, further comprising first and second engagement portions provided respectively at opposite sides of the first jaw and at opposite sides of the second jaw, said first and second engagement portion of the first and the second jaw forming together an embracing configuration for gripping the port of the operating handle and the multilumen tubing.

5. A device according to claim 4, wherein the first and the second engagement portion being configured as an arched protrusion for gripping the multilumen and the port when the first and the second jaw being in the normally closed position.

6. A device according to claim 1, wherein the heating assembly comprises an anvil and the heating element comprises a heating strip tensioned over the anvil.

7. A device according to claim 6, further comprising a tensioning assembly for adjusting the tension of the heating strip over the anvil.

8. A device according to claim 1, further comprising a control assembly for controlling one or more of the following parameters: heating temperature, heating time.

9. A device according to claim 2, further comprising a means for monitoring size of the tube receiving gap.

10. A device according to claim 2, wherein size of the tube receiving gap is controlled by an optical means.

11. A device according to claim 2, wherein size of the tube receiving gap being controlled by a comb-like element connected to the first jaw and by an optical switch, wherein said comb-like element and the optical switch being relatively displaceable.

12. A device according to claim 1, further comprising a heat hazard illuminated indication.

13. A method for heat-sealing a disposable multilumen tubing used with an endoscopic apparatus, the method comprising the steps of:
(a) providing a device comprising: a first jaw and a second jaw pivotally articulated to one another, each having a front portion and a rear portion; at least one heating assembly fixed within the front portion of at least one of the jaws, said heating assembly comprising a heating element; said heating assembly being electrically connectable to an energy source; at least one operating handle engagement portion for positioning of the device with respect to a port provided at an operating handle of the endoscopic apparatus and for fixation of the device with respect to the multilumen tubing.
(b) pivoting the jaws to create a tube receiving gap, which allows positioning of the multilumen tubing between the first and the second jaws;
(c) initial squeezing of the multilumen tubing by said first and second jaw; and
(d) applying electrical power to the heating strip for heat-sealing of the multilumen tubing, while the first and the second jaws squeeze thereof.

14. A method according to claim 13, wherein the first jaw and the second jaw of the device are normally biased and the front portions thereof being kept in a normally closed position.

15. A method according to claim 13, wherein the engagement portions form together an embracing configuration for gripping the port of the operating handle and the multilumen tubing.

16. A method according to claim 13, wherein the engagement portions being configured as arched protrusions provided at opposite sides of the first and the second jaw.

17. A method according to claim 13, wherein the device further comprises a control assembly for controlling one or more of the following parameters: heating temperature, heating time.

18. A method according to claim 13, further comprising monitoring a size of the tube receiving gap.

19. A method according to claim 13, further comprising controlling a size of the tube receiving gap.

20. A method according to claim 19, further comprising controlling the size of the tube receiving gap by an optical means.
